(19) United States
(12) Patent Application Publication
(10) Pub. No.: US 2025/0335831 A1
(43) Pub. Date: Oct. 30, 2025

(54) REVERSE ENGINEERING MACHINE-LEARNING MODELS THROUGH DATA POISONING TECHNIQUES

(71) Applicant: Datalytica LLC, Laurel, MD (US)

(72) Inventors: Misty Karina Blowers, Laurel, MD (US); Meredith Ann Jones, Edmond, OK (US); Jonathan Ross Williams, Laurel, MD (US)

(21) Appl. No.: 19/096,194

(22) Filed: Mar. 31, 2025

Related U.S. Application Data
(60) Provisional application No. 63/640,157, filed on Apr. 29, 2024.
(60) Provisional application No. 63/667,407, filed on Jul. 3, 2024.

(51) Int. Cl. G06N 20/20

(52) U.S. Cl. CPC G06N 20/20

(57) ABSTRACT

Disclosed are configurations to enable reverse engineering and characterizing machine learning algorithms through controlled data manipulation. A target machine learning system is analyzed by obtaining compatible data, applying data poisoning techniques to induce controlled responses, and generating a unique model signature that quantifies the system's response patterns. The model signature is compared against a codebook of known algorithm signatures to identify the underlying algorithm type. The codebook is built and maintained by applying systematic data manipulations, such as data poisoning techniques, to known machine learning algorithms and recording their characteristic responses. Multiple data poisoning techniques may be applied sequentially, with features extracted from the system's responses assembled into multi-dimensional feature vectors. This approach enables identification and vulnerability assessment of machine learning systems without requiring access to their internal structures or source code, supporting both offensive operations to identify vulnerabilities and defensive operations to enhance robustness.

### CROSS-REFERENCE TO RELATED APPLICATIONS

This application claims the benefit of, and priority to, U.S. Provisional Application No. 63/640,157, filed on Apr. 29, 2024, and of U.S. Provisional Application No. 63/667,407, filed on Jul. 3, 2024, each of which is incorporated by reference.

### FIELD OF ART

The present disclosure relates generally to the field of artificial intelligence and machine learning (AI/ML), and more specifically to a system and method for reverse engineering, classifying, and characterizing the underlying learning mechanisms of various classes of AI/ML algorithms.

### BACKGROUND

AI/ML systems have revolutionized various sectors, such as cybersecurity, finance, healthcare, automotive, telecommunications, and e-commerce, by providing automated solutions for complex problems that require data analysis, decision making, and optimization. However, the complexity and opaqueness of AI/ML systems also introduce significant challenges in understanding, evaluating, and securing these systems, especially in the face of adversarial attacks and model manipulation, such as data poisoning.

Adversarial data poisoning attacks are malicious attempts to compromise the integrity or functionality of AI/ML systems by exploiting their vulnerabilities, such as sensitivity to input perturbations, susceptibility to data manipulation, or lack of robustness in responding to changes to data distribution. Frequently, data poisoning attacks may cause model drift (referring to the phenomenon where the performance of AI/ML systems degrades over time due to changes in the data or environment that deviate from the initial assumptions or conditions), may influence the behavior of an AI/ML system in undesirable ways, and may overall negatively affect the accuracy of the system by introducing corrupt, misleading, or strategically designed inputs. These inputs may alter or degrade the performance of the system during its training or validation processes. Likewise, data poisoning may involve targeted changes to an AI/ML models' underlying algorithms, model parameters, or training dynamics. The objective of such attacks is to induce specific, harmful behaviors or vulnerabilities within the system, compromising its integrity, accuracy, or functionality. Notably, the scope of data poisoning remains fluid, with emerging techniques continuously evolving to exploit new vulnerabilities.

While training data directly influences how an AI/ML model learns, validation data is used to evaluate the model's generalization ability and fine-tune hyperparameters. By poisoning the validation set, an attacker can mislead the model's assessment, causing it to appear more accurate or robust than it really is. This could lead to overfitting, false confidence in the model's performance, or poor decisions in model selection.

Each of these challenges warrant systems and methods capable of understanding the operating mechanisms of AI/ML systems to, in turn, enable their protection or, in the case of an adversary's AI/ML system, exploit their vulnerabilities, but understanding and/or reverse engineering those operating mechanisms can be a significantly challenging task.

Traditional methods for evaluating AI/ML systems primarily aim to provide insights into model accuracy, fairness, transparency, and the outcomes of AI-driven decision-making. However, these methods often lack the depth necessary for understanding the intricate underlying learning mechanisms of AI/ML algorithms, particularly, in black-box models where the internal workings remain unknown or are inaccessible. This opacity makes it difficult to discern how the model arrives at its predictions, limiting interpretability and hindering efforts to diagnose errors or biases. While traditional evaluation methods offer visibility into model outputs and behaviors, these methods do not provide a systematic framework for inducing controlled model failures, a critical aspect when analyzing vulnerabilities in AI/ML systems, especially under adversarial conditions.

Therefore, there remains a need in the art for advanced systems and methods that enable the reverse engineering and characterization of the underlying learning mechanisms of various classes of AI/ML algorithms, without requiring access to their internal structures or source code.

### SUMMARY

The present disclosure relates generally to the field of artificial intelligence and machine learning (AI/ML). Specifically, system, method, and non-transitory computer readable storage medium configurations are disclosed for reverse engineering, classifying, and characterizing the underlying learning mechanisms of various classes of AI/ML algorithms via intentional model manipulation, such as data poisoning, and to systems and methods for assessing the security of AI/ML algorithms and for quantifying the impact of such manipulation strategies against AI/ML systems to enable more robust protection of such systems.

As described above, traditional methods for adversarial attack detection and model evaluation often rely on monitoring the system's outputs or identifying atypical patterns in model behavior. However, these methods fall short in providing a deep understanding of the system's inner workings or a systematic way to interrogate the model under adversarial conditions. Additionally, these methods struggle to effectively discriminate between different types of AI/ML models, making it difficult to account for variations in how different ML backbones respond to adversarial inputs. As a result, evaluation outcomes may be inconsistent or misleading, as the effectiveness of detection and defense mechanisms can vary significantly depending on the underlying AI mechanism.

The disclosed configurations fill this gap by applying data poisoning techniques in order to strategically induce controlled AI/ML model failures, allowing for precise identification of vulnerabilities and providing insight into how different types of poisoning attacks affect the system. Through examination and comparison of the effects of such poisoning attacks on various classes of AI/ML models, such systems and methods enable the reverse engineering and characterization of the underlying learning mechanisms of those AI/ML models without requiring access to their internal structures or code. More particularly, such disclosed configurations analyze AI/ML systems' responses to adversarial attacks and data poisoning in order to characterize their underlying learning mechanisms for purposes of both offensively enabling the reverse engineering of an adversary's AI/ML system to identify vulnerabilities, exploit functionality and/or manipulate the target systems' algorithms, and defensively to identify, analyze, and address vulnerabilities within an internal AI/ML system to enhance robustness. The technology may further be extended to other algorithms that underpin embedded systems that can independently make decisions, learn from their environment, and/or execute tasks without human intervention, such as (by way of non-limiting example) Probabilistic Reasoning, Complex Decision Hierarchies, and rule-based logic.

This approach not only enhances transparency and understanding of AI/ML systems but also improves security by enabling more accurate detection of malicious activities. Moreover, it enables the development of tailored responses to specific attacks, supporting the creation of more robust policies and regulations for the ethical and responsible use of AI/ML technologies. By comparing the dissimilarities and similarities between various models, we can establish a high degree of certainty in identifying and characterizing specific AI/ML models, setting the methods described herein apart from traditional methods that focus solely on output manipulation without probing deeper into the model's design and architecture.

Certain aspects of a disclosed embodiments may uncover the underlying learning mechanisms of AI/ML algorithms through intentional data poisoning. First, a codebook of AI/ML model signatures may be developed through controlled and intentional data poisoning of those AI/ML models, offering a tangible framework for analyzing AI/ML behavior. Second, a detailed, practical reverse engineering process interacts with “target” AI/ML models that are to be evaluated (such as through APIs or hardware interfaces), in which the unknown AI/ML model algorithm may be characterized through the comparison of observed responses of that AI/ML model algorithm to data poisoning methods against the codebook of known algorithm responses to data poisoning methods, thus providing a concrete method for quantifying the response of various AI models to different poisoning strategies.

The disclosed configurations may exhibit one or more of the following features and benefits. First, such systems and methods may exhibit broad applicability through their capability of reverse engineering a variety of AI/ML algorithms, and particularly significantly more than only neural networks. Such AI/ML algorithms to which the methods disclosed herein may be applied include (by way of non-limiting example) support vector machines, decision tree-based classifiers, Bayesian classifiers, neural-network based classifiers, linear regression models, linear classifiers, and such other AI/ML algorithms as will occur to those skilled in the art. Further, the disclosed configurations may offer a true black-box approach to evaluating target AI/ML systems, operating without any prior knowledge of that target system's architecture and requiring only the model inputs and outputs to reverse engineer that target system. Still further, the disclosed configuration make use of unique AI/ML model signatures, deploying unique poisoning techniques to elicit distinct responses from target systems. By analyzing and enumerating these responses, unique algorithmic model signatures may be generated for each AI/ML model, which model signatures are assembled into a codebook that enables accurate identification and differentiation of black-box AI/ML models with precision. Such configurations may provide a practical process for characterizing AI/ML models by inducing failures and analyzing responses, leading to tangible improvements in security and performance.

Even further, the disclosed configurations offer flexible use cases, supporting both defensive applications (such as vulnerability analysis and robustness testing) and offensive cases (such as penetration testing and algorithm manipulation). Likewise, the disclosed configurations may enable a detailed audit trail and non-invasive analysis technique, ensuring the integrity of AI/ML systems while providing a clear framework for understanding and improvement.

The disclosed configurations offer a technical advancement in the field of AI/ML, offering a novel, concrete method for the reverse engineering and characterization of AI/ML algorithms. The configurations beneficially solve the technical problem of opaque and unanalyzable AI/ML systems by providing a practical framework for inducing model failure under controlled conditions and systematically analyzing the results. This significantly enhances the transparency, security, and performance of AI/ML systems, contributing to the development of effective policies and regulations for ethical and responsible use.

In some aspects, the techniques described herein relate to a method including: applying each of a set of data poisoning techniques to a target machine-learning model associated with a target computing system; measuring, for each of the set of data poisoning techniques applied to the target machine-learning model, a corresponding performance of the target machine-learning model; computing a set of feature values for the target machine-learning model based on the measured performance of the target machine-learning model for the set of data poisoning techniques applied to the target machine-learning model; identifying a model structure for the target machine-learning model by comparing the set of feature values computed for the target machine-learning model to a stored plurality of model poisoning fingerprints, each fingerprint corresponding to previously generated features describing a performance of a corresponding machine-learning model structure of a plurality of machine-learning models structures after applying a set of data poisoning techniques to a machine-learning model of the corresponding machine-learning model structure; and transmitting an indication of a match to a fingerprint in response in response to identifying the model structure.

In some aspects, the techniques described herein relate to a method, further including generating the plurality of model poisoning fingerprints by: applying the set of data poisoning techniques to a plurality of machine-learning models, wherein the plurality of machine-learning models include at least one machine-learning model of each of the plurality of machine-learning model structures; and measuring a performance of each of the plurality of machine-learning models to generate the model poisoning fingerprints for the plurality of machine-learning model structures.

In some aspects, the techniques described herein relate to a method, wherein each of the model poisoning fingerprints includes a feature vector including feature values for a plurality of features describing a performance of the corresponding machine-learning model structure.

In some aspects, the techniques described herein relate to a method, wherein each of the model poisoning fingerprints includes an embedding vector describing a performance of the corresponding machine-learning model structure.

In some aspects, the techniques described herein relate to a method, wherein the set of data poisoning techniques includes at least one of: label flipping; backdoor attacks; injection of outliers; gradient poisoning; trojan attacks; incremental insertion points; gradient inversion poisoning; centroid line poisoning; outlier sensitivity testing; feature perturbation testing; distribution skew injection; class-specific noise injection; or gradient-free attack simulation.

In some aspects, the techniques described herein relate to a method, wherein the plurality of machine-learning model structures include at least one of a support vector machine, a random forest classifier, a Gaussian Naïve Bayes classifier, or a neural network.

In some aspects, the techniques described herein relate to a method, wherein applying each of the set of data poisoning techniques to a target computing system includes: predicting a decision-making structure of the target machine-learning model.

In some aspects, the techniques described herein relate to a method, wherein the predicted decision-making structure includes at least one of a binary classifier, a multi-classifier, a regression model, or a time series.

In some aspects, the techniques described herein relate to a method, wherein computing a set of feature values for the target machine-learning model includes: computing a precision or a recall of the target machine-learning model.

In some aspects, the techniques described herein relate to a method, wherein identifying the model structure for the target machine-learning model includes: applying a k-nearest-neighbors process to the computed set of feature values and the stored plurality of model poisoning fingerprints.

In some aspects, the techniques described herein relate to a non-transitory computer-readable medium storing instructions that, when executed by a computer system, cause the computer system to perform operations including: applying each of a set of data poisoning techniques to a target machine-learning model associated with a target computing system; measuring, for each of the set of data poisoning techniques applied to the target machine-learning model, a corresponding performance of the target machine-learning model; computing a set of feature values for the target machine-learning model based on the measured performance of the target machine-learning model for the set of data poisoning techniques applied to the target machine-learning model; identifying a model structure for the target machine-learning model by comparing the set of feature values computed for the target machine-learning model to a stored plurality of model poisoning fingerprints, each fingerprint corresponding to previously generated features describing a performance of a corresponding machine-learning model structure of a plurality of machine-learning models structures after applying a set of data poisoning techniques to a machine-learning model of the corresponding machine-learning model structure; and transmitting an indication of a match to a fingerprint in response in response to identifying the model structure.

In some aspects, the techniques described herein relate to a computer-readable medium, the operations further including generating the plurality of model poisoning fingerprints by: applying the set of data poisoning techniques to a plurality of machine-learning models, wherein the plurality of machine-learning models include at least one machine-learning model of each of the plurality of machine-learning model structures; and measuring a performance of each of the plurality of machine-learning models to generate the model poisoning fingerprints for the plurality of machine-learning model structures.

In some aspects, the techniques described herein relate to a computer-readable medium, wherein each of the model poisoning fingerprints includes a feature vector including feature values for a plurality of features describing a performance of the corresponding machine-learning model structure.

In some aspects, the techniques described herein relate to a computer-readable medium, wherein each of the model poisoning fingerprints includes an embedding vector describing a performance of the corresponding machine-learning model structure.

In some aspects, the techniques described herein relate to a computer-readable medium, wherein the set of data poisoning techniques includes at least one of: label flipping; backdoor attacks; injection of outliers; gradient poisoning; trojan attacks; incremental insertion points; gradient inversion poisoning; centroid line poisoning; outlier sensitivity testing; feature perturbation testing; distribution skew injection; class-specific noise injection; or gradient-free attack simulation.

In some aspects, the techniques described herein relate to a computer-readable medium, wherein the plurality of machine-learning model structures include at least one of a support vector machine, a random forest classifier, a Gaussian Naïve Bayes classifier, or a neural network.

In some aspects, the techniques described herein relate to a computer-readable medium, wherein applying each of the set of data poisoning techniques to a target computing system includes: predicting a decision-making structure of the target machine-learning model.

In some aspects, the techniques described herein relate to a computer-readable medium, wherein the predicted decision-making structure includes at least one of a binary classifier, a multi-classifier, a regression model, or a time series.

In some aspects, the techniques described herein relate to a computer-readable medium, wherein computing a set of feature values for the target machine-learning model includes: computing a precision or a recall of the target machine-learning model.

In some aspects, the techniques described herein relate to a computer-readable medium, wherein identifying the model structure for the target machine-learning model includes: applying a k-nearest-neighbors process to the computed set of feature values and the stored plurality of model poisoning fingerprints.

Still other aspects, are readily apparent from the following detailed description, simply by illustrating a number of particular embodiments and implementations, including the best mode contemplated.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a flowchart providing a summary view of a method for black-box evaluation of AI/ML-enabled systems, in accordance with some embodiments.

FIG. 2 is a schematic view of a system for implementing the process of FIG. 1.

FIG. 3 is a detailed flowchart of a method for generating codebook entries for use in the method of FIG. 1.

FIG. 4 is an exemplary view of a graphical user interface for developing a codebook for use in the process of FIG. 1.

FIG. 5 is an exemplary view of a graphical user interface for reverse engineering an unknown machine learning algorithm for use in the process of FIG. 1.

FIG. 6 is a schematic view of a computing device for use with the system of FIG. 2.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview of Example Embodiments

A model evaluation system is a computing system that uses data poisoning techniques to evaluate third-party machine-learning (ML) models and identify the structure of those models.

The model evaluation system stores a set of model poisoning fingerprints. These fingerprints (which also may be referred to herein as “codebooks”) are representations of changes in performance of a machine-learning model when data poisoning techniques are applied to that model. Each of the model poisoning fingerprints is associated with a corresponding ML model structure. For example, the model evaluation system may store separate fingerprints for support vector machines, random forest classifiers, Gaussian Naïve Bayes classifiers, and neural networks.

Each model poisoning fingerprint store values for features that describe the performance of a corresponding ML model structure when that structure is subjected to data poisoning. For example, a fingerprint may include a feature vector that contains values for different performance metrics for the corresponding ML model structure (e.g., recall or precision metrics for the ML model structure). These fingerprints also may include features that are specific to a corresponding data poisoning technique, such as how the data poisoning technique was applied. For example, if an incremental insertion point poison technique is applied to a particular ML model structure, the fingerprints may include the number of insertion points used. In some embodiments, these feature values are normalized by applying a normalization function to the feature vectors. Similarly, in some embodiments, each fingerprint includes an embedding generated by inputting a feature vector into an embedding model that is trained to generate embeddings for ML model structures. For example, the embedding model may be trained based on labeled training data, wherein each training example in the training data has input features describing the performance of a model and a label that indicates a type of ML structure for the model. In some embodiments, the fingerprints include aggregated feature vectors or embedding vectors, which are vectors that are aggregated based on vectors computed for each of the set of data poisoning techniques.

The system generates model poisoning fingerprints by testing the performance of individual ML model structures subjected to data poisoning. By employing a data poisoning technique with starting with a “clean ML model” training data is not compromised and provide for observed effects from a specific poisoning strategy. By way of example, the system may apply a set of data poisoning techniques to an ML model and measure the performance of the ML model after the techniques are applied. The system may measure the ML model's performance by comparing a ground truth label for an input to the ML model to the output of the ML model. For example, the system may compute the precision or recall of the model. In some embodiments, rather than testing the ML model directly, the online system applies its experiments through a computing system that uses the ML model for its functionality. For example, if a computing system uses the ML model to classify malicious behavior within a network, the model evaluation system may test the ML model by testing whether the computing system correctly or incorrectly identifies its behavior within the network as malicious or benign.

In some embodiments, the system generates model poisoning fingerprints by applying each data poisoning technique to a clean ML model (i.e., a model whose training data has not been compromised) and generates separate feature values for the fingerprints based on the model's performance when poisoned by the corresponding technique. Similarly, the system may generate the model poisoning fingerprints by applying subsets of a full set of available data poisoning techniques to ML structures. For example, the system may test an ML model structure's performance when different subsets of the data poisoning techniques are applied. In some embodiments, the system tests all possible subsets of the data poisoning techniques for each of the ML model structures. The system may generate separate feature values for each data poisoning technique or subset of data poisoning techniques. The system may compute separate precision values for when incremental insertion points are applied, when gradient inversion poisoning is applied, and when both are applied. Each of these feature values may be included in a fingerprint for the corresponding ML model structure. In some embodiments, the system computes a metric of collinearity across different data poisoning techniques as features to include in the model poisoning fingerprints.

The model evaluation system uses the stored fingerprints to identify the structure of a third-party ML model. To identify the model's structure, the system applies data poisoning techniques to that ML model and evaluates the performance of the model after the techniques are applied. The model evaluation system may employ different approaches to applying these techniques depending on the context. For example, a third-party system may coordinate with the model evaluation system to test its ML model for vulnerabilities. In these contexts, the model evaluation system may apply the data poisoning techniques to the target ML model directly or through a target computing system that uses the target ML model.

In other contexts, the model evaluation system may be used to identify vulnerabilities in a target system for strategic applications or for white hat operations. In these contexts, the model evaluation system may only interact with the target model through the target system and possibly without the awareness of the third party controlling the target system. In these contexts, the model evaluation system may use a multi-staged cyber attack strategy to access the target model through the target system.

In some embodiments, the model evaluation system makes an initial prediction of a decision-making structure of the target model. The decision-making structure of a model represents a general structure or type of output of the target model. Example decision-making structures include binary classifications, multi-class classifications, regressions, and time series. The model evaluation system may predict the decision-making structure of the target model based on determined types of inputs to the target model or a predicted type of output of the model. The model evaluation system may deploy different data poisoning techniques depending on the decision-making structure of the target model. For example, the model evaluation system may store a mapping of decision-making structures to sets of data poisoning techniques to be used. In some embodiments, the model evaluation system receives the decision-making structure of the target model from a human operator of the system.

The model evaluation system measures the performance of the target system or target ML model and computes a set of feature values for the target ML model based on the measured performance. For example, the model evaluation system may compute a feature value for each feature in the model poisoning fingerprints. In some embodiments, the model evaluation system computes feature values by testing the behavior of the target system that uses the target ML model. For example, if the target system uses the target ML model to detect malicious behavior within a network, the model evaluation system may intentionally commit malicious behavior within the network and determine whether the target ML model correctly identifies the behavior as malicious. Similarly, if the target system uses the target ML model to analyze sensor data, the model evaluation system may inject sensor data into the data stream, corrupt the sensor, or disrupt sensor readings (e.g., through inserting decoys into a scene). The model evaluation system may measure model performance through other means, like a backdoor generated through a cyber attack. Through tests like these, the model evaluation system can compute values for features of the target ML model without direct access to the ML model.

The model evaluation system compares the measured performance of the target ML model to the stored fingerprints to identify a model structure for the target ML model. For example, the system may generate a model poisoning fingerprint for the target ML model and compare the target model's fingerprint to the stored fingerprints. The model evaluation system may compute a distance between feature vectors in the fingerprints to determine how similar the fingerprints are to each other. Similarly, where the fingerprints include embedding vectors, the model evaluation system may use a distance or cosine similarity of the embedding vectors to compute a similarity score between the target ML model and the model structures of the stored fingerprints. In some embodiments, the model evaluation system uses a k-nearest neighbors analysis to identify a model structure for the target ML model.

In some embodiments, the model evaluation system iteratively applies data poisoning techniques to the target ML model and measures the performance of the target ML model after each iteration. The model evaluation system may use the performance measured with each iteration to determine whether the system can identify a model structure for the target ML model (e.g., that a confidence in the predicted model structure meets or exceeds a threshold value (or level)). If the model evaluation system identifies a model structure, the system may stop the iterative process. If the system is unable to identify the model structure based on the performance measured, the system may continue the iterative process with another poisoning technique.

The model evaluation system stores data describing the identified model structure for the target model and the target system. The system may use the data describing the model structure to determine a model poisoning strategy for the target system. For example, the system may select a subset of the model poisoning techniques to apply to the target system. Additionally, model evaluation system may use the stored data to assess potential vulnerabilities of a ML model and to monitor for poisoning attacks. In some embodiments, the system uses the identified model structure to simulate real-world cyberattacks against the target system. Furthermore, the model evaluation system may transmit an indication to a client device describing the identified model structure. For example, the model evaluation system may instruct a user interface on the client device to update to cause a visual or audio notification to be presented to the user.

### FURTHER DESCRIPTION OF EXAMPLE EMBODIMENTS

The present disclosure relates to the field of artificial intelligence and machine learning (AI/ML), with a particular focus on reverse engineering and characterizing the learning mechanisms of various AI/ML algorithms. Specifically, disclosed configurations of systems, methods, and/or non-transitory computer readable storage mediums comprising stored instructions analyze responses from AI/ML systems to data poisoning attacks.

By way of example, the disclosed configurations strategically induce model failure through data poisoning under controlled conditions, allowing for the extraction of key features that quantify the model's response to adversarial manipulation. These extracted features form a unique model signature, capturing distinguishing characteristics that discriminate the algorithm's response to data changes from other algorithms. These model signatures are then systematically assembled into a structured codebook, enabling comparative analysis across different AI/ML architectures. The codebooks facilitate histogram-based and vector quantization analysis, allowing users to assess performance metrics and gain a deeper understanding of the model's robustness, vulnerabilities, and decision-making behavior-all without requiring access to the AI/ML system's internal structure or code.

As will be further detailed below, the disclosed configurations may be deployed in both offensive operations, such as to reverse engineer an adversary's AI-enabled system to identify vulnerabilities or exploit functionality, and in defensive operations, such as to identify and address vulnerabilities within an internal AI-based system to enhance robustness. The disclosed configurations beneficially enhance the transparency and understanding of AI/ML systems, improve their performance and security, and aid in the development of effective policies and regulations for their ethical and responsible use.

Designed to be integrated with existing tools and frameworks, the disclosed configurations offer a seamless way to evaluate and understand complex AI/ML models. Their applications are broad, suitable for various types of both governmental and non-governmental entities and are applicable across commercial industries including (by way of non-limiting example) cybersecurity, finance, healthcare, automotive, telecommunications, and e-commerce.

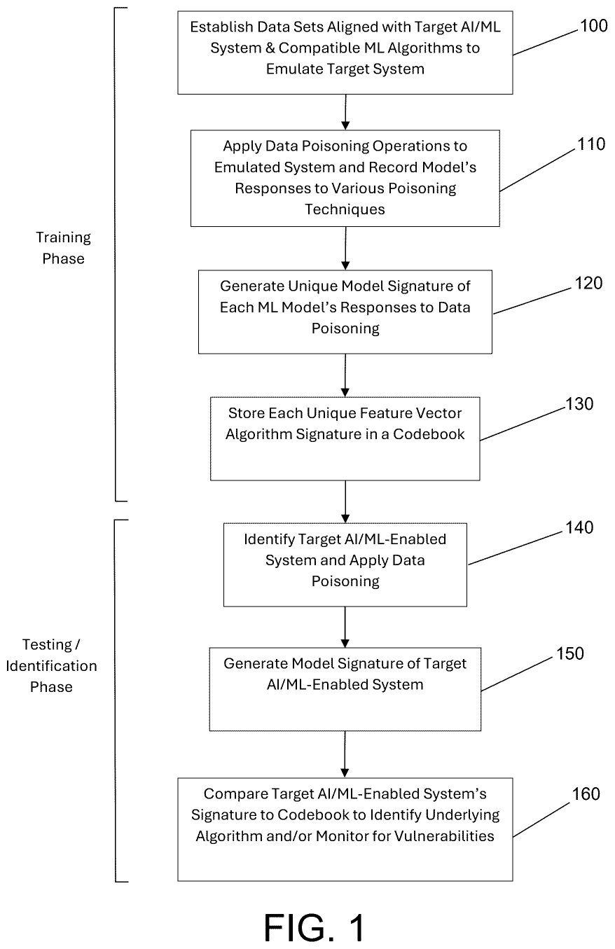

By way of example, Figure (FIG. 1 is a high-level summary flowchart providing an overall view of a method for black-box evaluation of AI/ML-enabled systems. The configuration as describe with FIG. 1 comprises a two-phased process. A first phase includes a training phase depicted in steps 100 through 130 and detailed below. A second phase includes a testing/identification phase depicted in steps 140 through 160 and detailed below. The phases utilize the codebooks to identify and classify AI/ML algorithms.

In a first step 100 of a training phase, data sets are obtained or created that are aligned with each target AI/ML system that is to be evaluated for purposes of generating a codebook, as discussed in detail below. Those data sets are selected or formatted such that they are aligned with the target AI/ML system and the particular data domain of that system (e.g., IoT data, industrial control system data, time-series data, image data, etc.). By way of non-limiting example, if a target AI/ML system is configured to use historical data to identify patterns and forecast future values (such as to predict future stock prices, sales forecasts, energy consumption, etc.), time series data will typically be used to identify patterns and forecast future values. In this case, a time series data set will be selected or generated. Likewise, if a target AI/ML system is intended to use structured data to predict future behavior (such as to predict customer behavior on a website based on historical purchases, demographics, and browsing activity to forecast future product purchases), a formatted structured data set will be selected or generated. Similarly, if a target AI/ML system is configured to use image data to analyze features in the images (such as for facial recognition, medical image analysis, navigation for self-driving vehicles, etc.), an image data set will be selected or generated.

Continuing in step 100, those AI/ML models that are known to be compatible with the selected or generated data set type are identified and loaded for training and ultimate emulation of the target AI/ML system. Again by way of non-limiting example, if the data set comprises time series data, each of a recurrent neural network, regression, decision tree, and gradient boosting AI/ML model may be loaded and trained using the selected or generated time series data set, such that poisoning techniques may be applied to each to generate a unique model signature for each poison type applied to each of those AI/ML models. Likewise, if the data set comprises structured data, each of a regression, decision tree, support vector machine, and gradient boosting AI/ML model may be loaded and trained using the selected or generated structured data set, and poisoning techniques applied to each to generate a unique model signature for each poison type applied to each of those AI/ML models. Still further, if the data set comprises image data, each of a convolutional neural network and a generative adversarial network AI/ML model may be loaded and trained using the image data set, and yet again poisoning techniques applied to each to generate a unique model signature for each poison type applied to each of those AI/ML models. It is noted that the data sets may be “clean data” and individually loaded so that a specific ML model may be analyzed with the poisoning techniques as described herein.

Next at step 110 (the second step of the training phase), data poisoning methods (detailed below) are applied to each emulated AI-enabled system to systematically capture and analyze each AI/ML model's behavioral response. Each emulated AI/ML model undergoes initial training using the associated selected or generated data set to establish a baseline performance metric, serving as a reference for subsequent adversarial manipulations of that AI/ML model. In some embodiments, this baseline performance metric is used to determine the robustness of a machine-learning model to adversarial manipulation.

Next, individual poisoning techniques are sequentially introduced, allowing for an isolated evaluation of that model's response to each specific poisoning attack type. The output of each AI/ML model in response to each applied poisoning method is monitored for changes reflecting failure of the model, which failures may be manifested as (by way of non-limiting example) model drift, model classifications/misclassifications, and other factors negatively impacting the accuracy of the AI/ML model. Those model failures may be evidenced by particular features (such as by way of non-limiting example, the number of data insertion points required to induce a misclassification, the rate of drift of the AI/ML model boundary, the acceleration of the rate of drift of the AI/M model boundary, changes in the numbers of true positive, true negative, false positive, and false negative metrics) that are extracted to create a unique model signature for a given poisoning method applied to a particular AI/ML model. By independently deploying each poisoning attack method against each AI/ML model, the method enables precise enumeration of failure modes and vulnerabilities inherent to the target AI/ML model. After each poisoning iteration, the baseline model is retrained to ensure that responses remain measurable and comparable across different poisoning scenarios.

Next at step 120 (the third step of the training phase), extracted features from all poisoning strategies used on a given AI/ML model are concatenated into a single representative feature vector, forming a unique signature for the AI/ML model. The unique signature for the AI/ML model allows for characterization of that AI/ML model to enable a precise differentiation between different AI/ML models based on their susceptibility and reaction patterns. Increasing the number and diversity of poisoning techniques will enhance the discriminatory power of those unique model signatures. By encoding these extracted characteristics into structure feature vectors, this step systematically quantifies model behavior under adversarial conditions, forming the foundation for AI/ML model classification, identification, and vulnerability assessment.

Next at step 130 (the fourth step of the training phase), each unique model signature is stored in a codebook database. The codebook database includes multiple unique feature vectors, each representing the unique model signatures for each AI/ML model's responses to the poisoning methods applied to that AI/ML model. That codebook database is then used during the testing/identification phase of the process of FIG. 1 (discussed below) to identify and characterize unknown AI/ML models.

As mentioned above, the testing/identification phase of the process of FIG. 1 leverages the codebook to systematically apply the foregoing steps to identify potential vulnerabilities in a target AI/ML-enabled system. At step 140 (the first step of the testing/identification phase), a target AI/ML system is selected whose underlying machine learning algorithms are unknown and are to be determined for purposes of identifying potential vulnerabilities. To extract key behavioral characteristics of that target AI/ML system, data poisoning methods as described above with respect to step 110 of FIG. 1 are applied to that target AI/ML system, allowing for the systematic recording of response patterns for the target AI/ML system under adversarial manipulation in the form of a unique model signature.

Next, at step 150 (the second step of the testing/identification phase), the model signature for the target AI/ML system is generated in the form of a feature vector, encapsulating a distinct reaction of a target AI/ML model to the applied poisoning techniques. This feature vector serves as the hallmark of the target AI/ML model's learning behavior, allowing for subsequent comparison against the codebook of known AI/ML algorithm signatures to facilitate identification and vulnerability assessment.

Next, at step 160 (the third step of the testing/identification phase), the signature of the target AI/ML system is compared against the codebook to determine its underlying algorithm and assess its vulnerability to poisoning attacks, using for example statistical distance metrics (further detailed below) to assess the similarity between the signature of the target AI/ML system and those unique model signatures stored in the codebook from the training phase. If the signature closely matches an existing entry in the codebook, the system is classified into a known AI/ML algorithm category with a corresponding confidence score. If the confidence score is at or above a threshold, the AI/ML model may be appropriately identified from the information in the codebook. If the confidence score is below a predefined threshold, the system is labeled as an unknown AI/ML algorithm, and its signature is added to the codebook, expanding the library of characterized AI/ML models. This continuous enrichment ensures that future systems can be more accurately identified and analyzed.

At this stage, if the configurations described herein are being used offensively against an adversarial AI/ML-enabled system, following identification of a backbone algorithm of the adversarial system as described above, and any identified vulnerabilities may then be exploited. Likewise, if the system and methods described herein are being used defensively to protect an internal AI/ML-enabled system, the system may be assessed for vulnerabilities and recommendations can be made of other potential machine learning models that may be more robust and less susceptible to attacks. Alternatively, recommendations can be provided to subvert various poisoning strategies when detected.

Furthermore, the described configurations may be used to check whether two code bases are similar to each other. For example, a code base asset may appear similar to another asset, but the underlying code base may be different because an adversary has injected into the supply chain. Furthermore, the described configurations may be used for litigation, such as to check for pirated software.

An example advantage of the foregoing reverse engineering process is the ability to provide a nuanced understanding of complex models without compromising their integrity or security. It beneficially provides a tool for both research and commercial applications, where understanding the behavior of AI/ML models may be important, but access to their internal workings may be restricted or undesirable due to security considerations, concerns about disclosing proprietary information, or the size of the target model's source code prohibits timely detailed analysis.

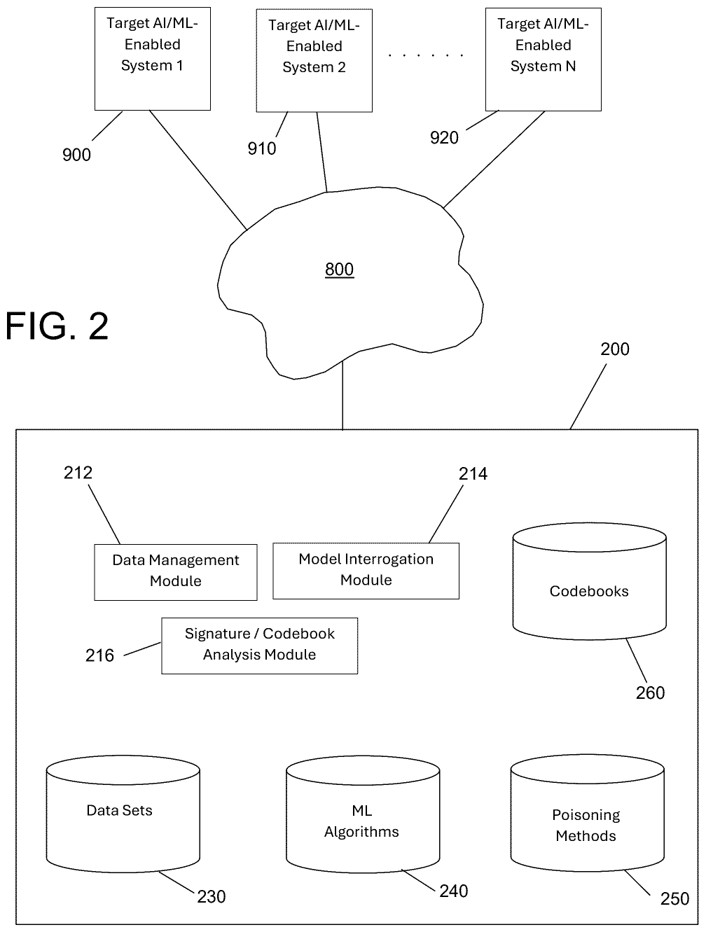

Next and in accordance with further aspects of an embodiment, FIG. 2 provides a schematic view of a computer-implemented system 200 for implementing the method for black-box evaluation of AI/ML-enabled systems of FIG. 1. System 200 is preferably in data communication with one or more target AI/ML enabled systems 900, 910, 920 through a network 800, such as a local data network, a wide area network such as the Internet, or such other wired or wireless networks as will readily occur to those skilled in the art. Those skilled in the art will recognize that other means may be employed for communicating system 200 with target systems, 900, 910, 920.

System 200 provides a modular and adaptable framework for simulating and evaluating AI/ML-enabled systems under various conditions. As part of this framework, a data management module 212 is configured to generate or accept externally provided datasets, enabling users to supply real-world or pre-curated data for simulation and evaluation purposes. This capability allows AI/ML-enabled systems to be tested under conditions that reflect real deployment scenarios. Data management module 212 supports various data formats and structures, ensuring seamless integration with diverse AI/ML frameworks. For example, data management module 212 may (by way of non-limiting example) generate or accept external time series data for AI/ML systems performing predictive analytics, sensor reading for AI/ML-enabled industrial control systems, visual or textual datasets for AI systems focused on image recognition or natural language processing, and such other types of data that may be processed by AI/ML-enabled systems and as may occur to those skilled in the art. Data generation module 212 preferably enables a user to customize the characteristics of the data that is to be processed by the simulated AI/ML-enabled system, including by defining parameters such as data size, structure, and complexity to align with the target system's requirements, creating variations in data to test system adaptability and robustness under different conditions, and inject anomalies or adversarial elements to evaluate how the system responds to unexpected or malicious inputs. Data management module 212 may likewise preprocess and adapt user-supplied datasets by normalizing, augmenting, or restructuring the data to fit the requirements of the target AI/ML-enabled system. Such data sets may be stored in a data set collection 230 for ease of access and for repeated uses in analyzing AI/ML enabled systems of similar types.

With continued reference to FIG. 2, system 200 includes a model interrogation module 214, which is configured to analyze both emulated known systems and actual unknown target systems as detailed above with respect to FIG. 1. Specifically, interrogation module 214 applies data poisoning techniques to those AI-enabled systems in order to extract features that quantify responses of the AI/ML model to data poisoning attacks. These features are then assembled into a unique model signature, again as detailed above with respect to the method shown in FIG. 1. This process of interrogation via intentional model manipulation enables the quantification of the particular response of the AI/ML-enabled system to data poisoning attacks.

System 200 includes a data collection of machine learning algorithms 240 that may be used to emulate a target AI-enabled system and a data collection of poisoning algorithms 250 (discussed below) that may be applied during interrogation by model interrogation module 214 to extract a system's unique algorithm signature for storage in codebook 260, which includes the collection of unique algorithm signatures representing the comprehensive list responses of machine learning models to applied data poisoning operations, which signatures can be used to help identify unknown algorithms. Each unique model signature in codebook 260 represents, via the particular features set forth in that unique model signature, the specific response of a given AI/ML model to a particular poisoning method applied to that model. Upon interrogation of an unknown AI/ML model, signature/codebook analysis module 216 may compare the unique model signature of the target AI/ML-enabled system to codebook 260 for identification and classification of that unknown AI-enabled system's model, all as further detailed below.

Conventional machine learning algorithms 240 to which the model interrogation module 214 may apply poisoning methods 250 to such varied machine learning algorithms 240 within the scope as described herein. By way of non-limiting example, such machine learning algorithms 240 may include Support Vector Machines (“SVMs”), random forest classifiers, multi-layer perception/artificial neural networks, Gaussian naïve bayes, hidden Markov models, logistic regression, decision tree classifiers, and the like as will readily occur to those skilled in the art.

As summarized above, system 200 constructs codebook 260, a structured repository designed to capture the unique model signatures of ML models in response to data poisoning techniques. The purpose of codebook 260 is to facilitate the identification and characterization of unknown ML algorithms by analyzing their responses to intentional adversarial manipulations. The generation of codebook 260 follows a structured process comprising six primary stages: data characterization, algorithm selection, data poison alignment, signature extraction, signature indexing, and library storage.

During data characterization, the data on the target system is either defined or sampled. From this characterization, a synthetic version of the data may be generated and pre-processed by data management module 212. Following dataset selection, algorithm selection is performed, in which the models under study will be selected from machine learning algorithms 240 for evaluation and unique model signature characterization. These models, in their untrained states, are identified, selected, and loaded by model interrogation module 214.

Once the dataset and machine learning models are prepared, model interrogation module 214 may conduct interrogation of each ML model independently using data poisoning methods 250. This allows for the assessment and quantification of resilience and behavior of a ML model under adversarial conditions. Each poisoning technique introduces a controlled perturbation, allowing model interrogation module 214 to extract distinguishing features that quantify a response of the ML model.

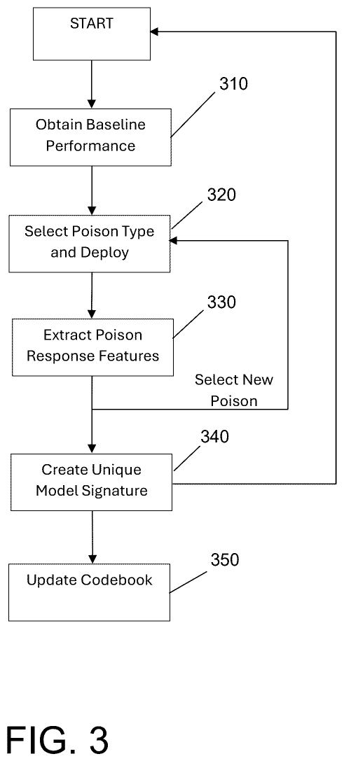

FIG. 3 is a flowchart showing the method for generating unique model signatures for storage in codebook 260. Following the preparation of the dataset and the machine learning models, and before deploying poisoning methods, a baseline performance assessment is conducted at step 310, where key performance metrics such as the baseline true positive, true negative, false positive, and false negative rates are recorded to establish a reference point. These baseline metrics are monitored both before and after the application of poisoning techniques to quantify their effects.

After a baseline is obtained from the ML model 240 undergoing interrogation, each selected poisoning method 250 is deployed sequentially at step 320. If multiple poisoning strategies are to be applied, each is executed independently on a freshly trained instance of the model to isolate its impact. Once a poisoning technique has been deployed, key response features are extracted at step 330, which features encapsulate a reaction of the ML model to the intentional adversarial manipulation. These steps are repeated for all poisoning techniques designated for the interrogation process.

Notably, each poisoning method 250 will have a particular set of key response features that may be extracted upon application of the respective poisoning method 250 to a selected ML model. By way of non-limiting example, when using of the poisoning type “incremental insertion points,” which gradually adds insertion points near the decision boundary, the set of features that may be extracted from application of that poison type may include (i) number of insertion points, (ii) rate of model drift, (iii) acceleration of model drift, and (iv) change in test set performance. Further, use of the poisoning type “centroid line poisoning,” in which training samples are perturbed by a small amount, the set of features that may be extracted from application of that poison type may include (i) number of samples perturbed and (ii) change in test set performance. Other poisoning techniques as discussed herein may likewise be used, each having associated features that may assist in discriminating a response of an ML model to a poisoning attack from those of other poisoning attack methods.

Assuming multiple poison methods 250 are to be applied to a particular ML model, a first poison method “A” may be deployed until a stopping criteria is met (e.g., a misclassification of input data), and following extraction of those features that are associated with that poison method “A”, a new baseline of that ML model may be established and second poison “B” may be deployed to extract those features that are associated with that poison method “B”. This process continues through application of all poison methods 250 that are to be applied to the subject ML model.

When selecting poison methods to deploy, the disclosed configuration deploys a range of poisoning methods (including all available poisoning methods) strategically based on the data characterization step and application domain. The process may be iterated until enough features are extracted to effectively differentiate between different model types selected during the training phase 100-130. The extracted features serve as quantifiable indicators of a response of the AI model to individual poisoning techniques, enabling a systematic assessment of model behavior under adversarial conditions. These features may include shifts in decision boundaries, variations in loss gradients, classification confidence changes, or other measurable deviations in model performance. In some example embodiments, selection of features may be based on rigorous experimentation to provide meaningful insights into the susceptibility and response dynamics of a ML model. By leveraging experimentally determined metrics, model reactions to different poisoning methods may be effectively quantified and compared to facilitate a structured approach to model evaluation and adversarial analysis. By systematically applying a variety of poisoning strategies, different ML model responses may be analyzed to identify key characteristics that distinguish them. Once a sufficient discriminatory power is achieve, enabling reliable classification of models based on their reactions to poisoned data, additional poisons may no longer be deployed and applied. This comprehensive approach ensures leveraging a full spectrum of poisoning techniques while maintaining efficiency in an analysis of model vulnerabilities and behavior.

Those skilled in the art will readily recognize that a wide variety of data poisoning techniques may be provided in poison methods 250 for application to different ML models. Thus, to leverage data poisoning for reverse engineering and producing unique signatures, systematic variations of data poisoning techniques may be used along with observation of the AI/ML-enabled system's output and patching response. This includes techniques that vary the intensity, type, and distribution of poisoned data. Feature extraction as described above is employed to analyze the behavior of the AI/ML-enabled system in response to each type of poisoning, allowing identification of patterns or inconsistencies in its learning process, decision-making, and error correction mechanisms. The feature extraction step allows extraction of unique signatures based on the system's response to a variety of different poisoning methods, including performance metrics, error rates, and response to patching. These signatures can encapsulate the system's resilience, adaptability, and vulnerability profile.

The disclosed configurations may leverage various data poisoning strategies that drive the interrogation of AI/ML-enabled systems. Each data poisoning method is a form of attack on AI/ML-enabled systems in which the training or validation data is maliciously altered or injected with incorrect information, intending to compromise the ML model's integrity or induce specific behaviors. By way of non-limiting example, data poisoning techniques that may be applied by system 200 may include label flipping (changing training data point labels from one class to another), backdoor attacks (inserting a trigger into the training data to cause the ML model to produce a specific incorrect output), injection of outliers or anomalous data into the training set (forcing the ML model to learn incorrect patterns or overfit to noise), gradient poisoning (altering the gradients used to update the model during training), trojan attacks (embedding malicious behavior within the ML model to be activated by specific inputs), and such other poisoning methods (both now existing and to be developed in the future) as will readily occur to those skilled in the art.

Upon completion of the application of all selected poison methods 250, system 200 proceeds to unique model signature creation and storage. At Step 340, extracted features from all applied poisoning techniques are compiled into a one-dimensional feature vector, forming the model's unique signature. This signature represents the model's behavioral signature under adversarial conditions. Finally, at Step 350, the compiled signature is stored as an entry in codebook 260, ensuring a structured and comparative database of ML model responses. This process is repeated for each machine learning algorithm that has been selected from ML algorithms 240.

Data poisoning methods 250 serve as a critical tool for reverse engineering AI/ML-enabled systems by systematically altering training data and observing the model's response. A wide variety of poisoning methods can be employed, each varying in intensity, type, and distribution of manipulated data. These poisoning methods function as targeted attacks on ML models, where training data is intentionally modified to compromise model integrity or induce specific behaviors. The extracted unique model signatures provide insights into how different models react to adversarial manipulation, aiding in the identification and characterization of unknown systems. By applying diverse poisoning strategies, the system can extract unique signatures that encapsulate a model's resilience, adaptability, and vulnerability profile.

An objective of codebook 260 is to provide an extensive catalog of ML model signatures, enabling system 200 to identify the ML model backbone of unknown models through black-box reverse engineering. By developing a library of signatures that enumerate specific characteristic responses of various AI/ML algorithms, codebook 260 facilitates model profiling and comparative analysis across a wide range of AI/ML systems.

To reverse engineer an unknown algorithm, system 200 follows a structured process leveraging the pre-existing codebook 260. First, a model signature for the unknown algorithm is generated using the same methodology applied to known models—by subjecting it to various data poisoning techniques and extracting its response features. Once the signature is obtained, it is compared against the stored signatures in codebook 260 using similarity metrics. By evaluating these similarities, system 200 may infer the most likely algorithmic type of the unknown model, effectively classifying it based on the signature it generates when subjected to the same data poison used in the training phase.

By way of non-limiting example, such comparison of a signature of the unknown ML model to the stored signatures in codebook 260 may be carried out using a distance metric, such as calculating the Euclidean or Manhattan distance between the unknown ML model signature and the stored model signatures in codebook 260. Given the unknown feature vector u=[u₁, u₂, . . . , uₖ] and known feature vector v=[v₁, v₂, . . . , vₖ], where k is the number of features, the Euclidean distance is defined as:

$$d ( u , v ) = \sqrt{{\sum }_{i = 1}^{k} {( {u}_{i} - {v}_{i} )}^{2}}$$

and the Manhattan distance is defined as:

$$d ( u , v ) = {\sum }_{i = 1}^{k} \vert {u}_{i} - {v}_{i} \vert$$

Likewise, and by way of further non-limiting example, K-nearest neighbors (“KNN”) may be used. KNN is a supervised ML classifier that uses proximity to classify a datapoint's group. It is a nonparametric algorithm commonly used in ML classification tasks. For KNN processing, samples in codebook 260 are considered as the training dataset. The labels of this training dataset will be the type of ML algorithm associated with each entry in the codebook. First, to determine a value for K, the value counts for each ML algorithm in the codebook (i.e., the value count for each label in the training set) are identified. K is defined as the smallest value count. This defines the number of nearest neighbors to use in the prediction. If K seems to be too large or too small, K is defined as the square root of the total number of entries in the training dataset. Note that in all instances, K must be an odd value. Next, the distance between the unknown algorithm feature vector and all other signatures in the training set is calculated. Next, the K closest points are chosen based off of the calculated distance. Finally, the unknown algorithm is assigned the label of the majority class among the K nearest neighbors.

The extracted features in each instance provide a quantification of how a decision boundary of the ML model changes during adversarial attacks. For each poisoning type, features are extracted that are reflective of the effort an adversary must expend to compromise the ML model. For example, for incremental insertion point poisoning discussed above, in which insertion points are iteratively added to the training dataset, the number of insertion points that an adversary needed to add to force a misclassification of the target set is quantified. Additionally, features that are non-specific to the poisoning method are extracted, such as the change in true positive, true negatives, false positives, and false negatives. This allows quantification of how performance changes for an ML model under adversarial stress.

Through this systematic approach, system 200 ensures a robust methodology for extracting, analyzing, and cataloging model signatures, allowing for the identification of unknown AI/ML models through intentional model manipulation and, thus, assessment of their resilience against adversarial threats. The foregoing process of identifying or classifying (i.e., reverse engineering) an unknown ML model used in an AI/ML-enabled system through such an interrogation process represents a groundbreaking approach that allows for the detailed analysis and understanding of artificial intelligence (AI) and machine learning models without requiring access to their internal structures or algorithms. By intentionally manipulating the input of a target ML model and observing the corresponding changes in the output, system 200 may deduce the underlying relationships, sensitivities, and robustness of the model. This reverse engineering process can be applied to various AI/ML-enabled systems, providing insights into their inner workings without needing to access the actual algorithms or codes. The process is designed to be modular, adaptable, and can be integrated with existing reverse engineering tools and frameworks, making it suitable for various applications across different domains and industries.

In contrast to conventional systems that take a specific known ML model and attempt to characterize the internal layers and weights (typically unique to a Neural Network only), the disclosed configurations beneficially examine the behavior and response of many different types of AI/ML models to various inputs, allowing for a generalized understanding that can be applied across different algorithms. The enumerative information extracted from the target model during interrogation is compared to the information stored in the codebooks along a multi-dimensional feature space. Without prior knowledge of inner workings of a particular ML model, the disclosed configurations provide insight into the type of model that is being assessed. Further, results of the codebook comparison may be presented to the user through an interface, including information of a ML model type most closely matching the features identified from the unknown target, and a confidence score, enabling the user to take any desired action targeted to the particular model type. The disclosed configurations provide a universal lens through which AI/ML algorithms may be explored and understood, opening new avenues for innovation, analysis, and application.

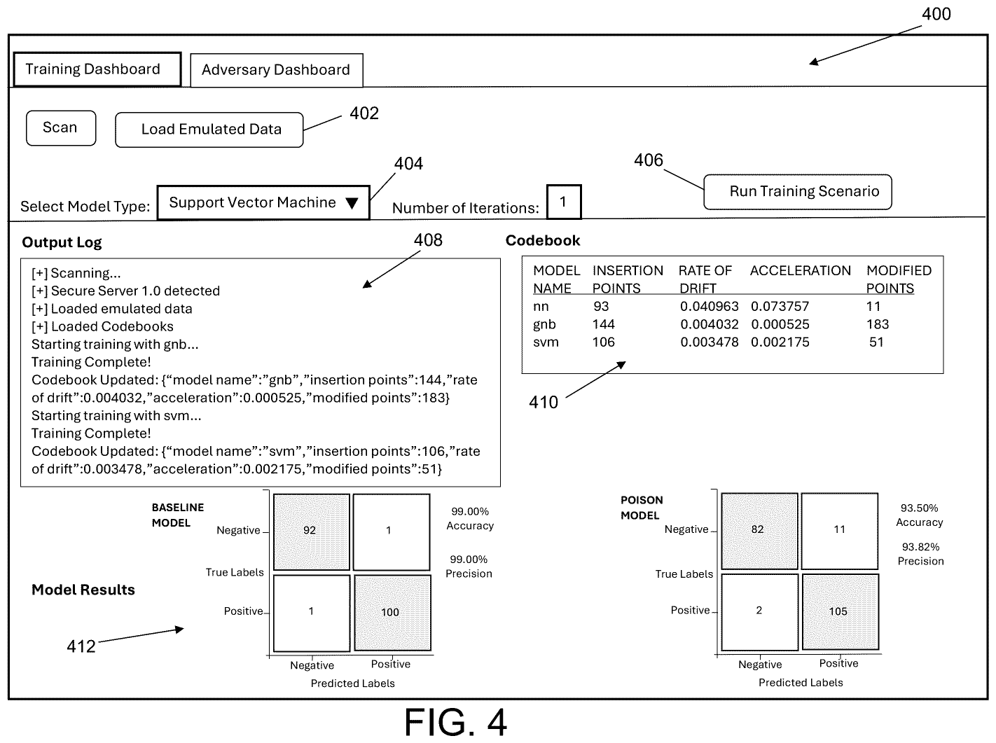

FIG. 4 is an exemplary user interface screen 400 enabling a user to engage the training phase depicted in FIG. 1, applying data poisoning methods 250 to ML models to generate codebook 260. A Load Emulated Data button 402 allows the user to select the dataset that is to be used to build the codebook 260. A Select Model Type drop-down menu 404 allows the user to select one of a wide variety of different ML algorithms that are to be processed to generate model signatures in codebook 260. A Run Training Scenario button 406 allows the user to begin interrogating the selected ML algorithm and generate the unique model signatures that will appear in codebook 260. An output log 408 provides a log of which ML algorithm is being run, when the training has completed, and the corresponding model signature that has been extracted. Likewise, codebook 410 shows the current model signatures that exist in codebook 260. Finally, a Model Results display 412 shows a confusion matrix for each of the baseline ML model and the poisoned ML model for easy graphical comparison.

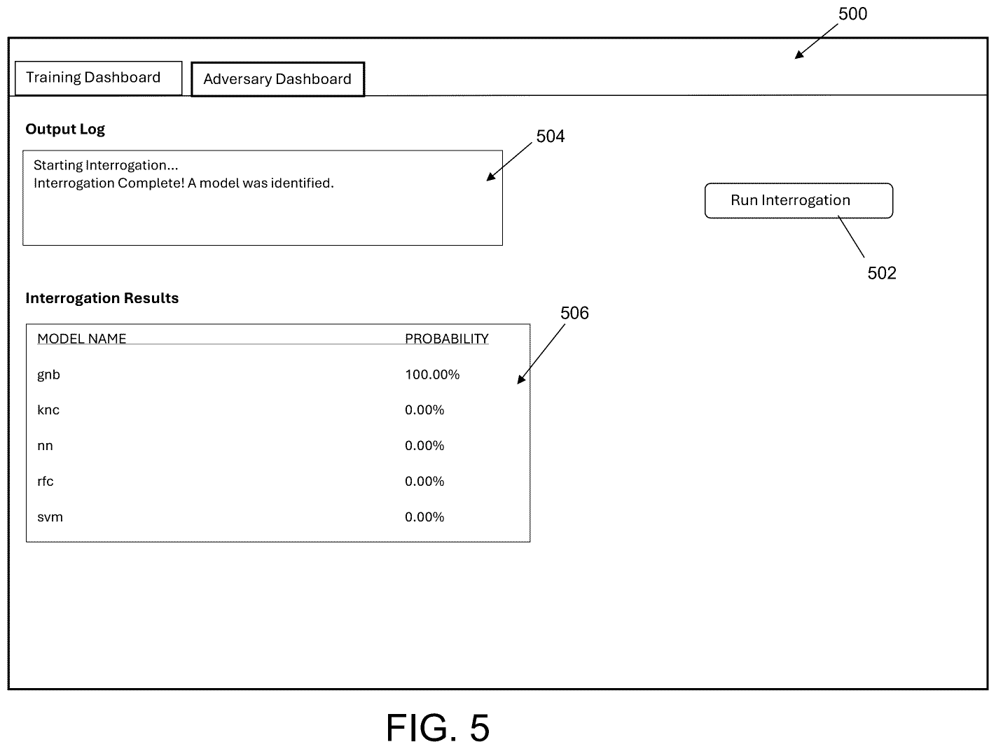

FIG. 5 is another exemplary user interface screen 500 enabling analysis for reverse engineer an unknown ML algorithm by comparing the unknown algorithm signature to those in codebook 260. A Run Interrogation button 502 allows the user to begin interrogating the unknown ML algorithm, generating a model signature as described above for comparison to model signatures in codebook 260. An Output Log 504 informs the user of when interrogation of the unknown ML algorithm begins and when it has completed. Finally, an Interrogation Results display 506 shows the user the percent probability that the unknown ML algorithm is one of the algorithms that exists in codebook 260.

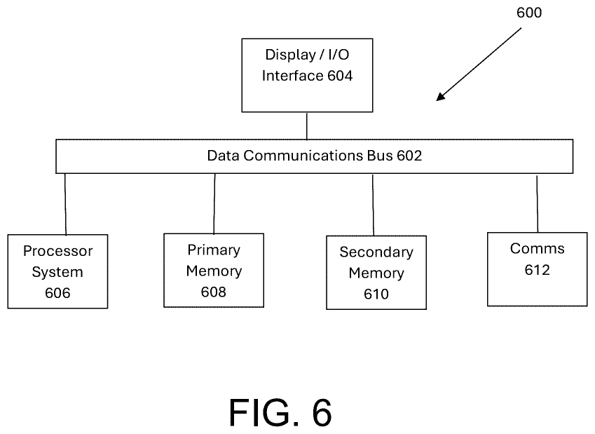

Those skilled in the art will recognize that system 200 and/or elements of system 200 may take the form of computer system 600 as reflected in FIG. 6, though variations thereof may readily be implemented by persons skilled in the art as may be desirable for any particular installation. In each such case, one or more computer systems 600 may carry out the foregoing methods as computer code.

Computer system 600 includes a communications bus 602, or other communications infrastructure, which communicates data to other elements of computer system 600. For example, communications bus 602 may communicate data (e.g., text, graphics, video, other data) between bus 602 and an I/O interface 604, which may include one of a display, a speaker, a microphone, a data entry device such as a keyboard, touch screen, mouse, or the like, and any other peripheral devices capable of entering and/or viewing data as may be apparent to those skilled in the art. Further, computer system 600 includes a processor system 606, which may comprise a special purpose or a general-purpose digital signal processor. The processor system may include one or more processors, for example, a central processing unit, a graphic processing unit, a neural processing unit (NPU), and/or a tensor processing unit (TPU). Still further, computer system 600 includes a primary memory 608, which may include by way of non-limiting example random access memory (“RAM”), read-only memory (“ROM”), one or more mass storage devices, or any combination of tangible, non-transitory memory. Still further, computer system 600 includes a secondary memory 610, which may comprise a hard disk, a removable data storage unit, or any combination of tangible, non-transitory memory. Finally, computer system 600 may include a communications interface 612, such as a modem, a network interface (e.g., an Ethernet card or cable), a communications port, a PCMCIA slot and card, a wired or wireless communications system (such as Wi-Fi, Bluetooth, Infrared, and the like), local area networks, wide area networks, intranets, and the like.

Each of primary memory 608, secondary memory 610, communications interface 612, and combinations of the foregoing may function as a computer usable storage medium or computer readable storage medium to store and/or access computer software including computer instructions. For example, computer programs or other instructions may be loaded into the computer system 600 such as through a removable data storage device (e.g., a floppy disk, ZIP disks, magnetic tape, portable flash drive, optical disk such as a CD, DVD, or Blu-ray disk, Micro Electro Mechanical Systems (“MEMS”), and the like). Thus, computer software including computer instructions may be transferred from, e.g., a removable storage or hard disc to secondary memory 610, or through data communication bus 602 to primary memory 608.

Communication interface 612 allows program code (software) and data to be transferred between the computer system 600 and external devices or external networks. The program code may be comprised of instructions executable by the processing system 606. For example, the processing flows and description of FIGS. 1-5, e.g., the functional flows and steps of predictive risk assessment and intervention, may be comprised as instructions stored in memory (e.g., 608 and/or 610 or other non-transitory storage medium) and executable by the processing system 606. Program code and/or data transferred by the communication interface 612 are typically in the form of signals that may be electronic, electromagnetic, optical or other signals capable of being sent and received by communication interface 612. Signals may be sent and received using a cable or wire, fiber optics, telephone line, cellular telephone connection, radio frequency (“RF”) communication, wireless communication, or other communication channels as will occur to those of ordinary skill in the art. The computer system 600 of FIG. 6 is provided only for purposes of illustration and is not limited to this specific embodiment.

Further, computer system 600 may, in certain implementations, comprise or include a handheld device and may include any small-sized computing device, including by way of non-limiting example a cellular telephone, a smartphone or other smart handheld computing device, a personal digital assistant, a laptop or notebook computer, a tablet computer, a hand held console, an MP3 player, or other similarly configured small-size, portable computing device as may occur to those skilled in the art.

In certain implementations, the system of FIG. 2 may be implemented in a cloud computing environment for carrying out the processing described herein. That cloud computing environment uses the resources from various networks as a collective virtual computer, where the services and applications can run independently from a particular computer or server configuration making hardware less important. The cloud computer environment may include at least one of data management module 212, model interrogation module214, and signature/codebook analysis module 216 configured as above operating as a client computer. The client computer may be any device that may be used to access a distributed computing environment to perform the methods disclosed herein, and may include (by way of non-limiting example) a desktop computer, a portable computer, a mobile phone, a personal digital assistant, a tablet computer, or any similarly configured computing device. That client computer preferably includes memory such as RAM, ROM, one or more mass storage devices, or any combination of the foregoing. The memory functions as a computer readable storage medium to store and/or access computer software and/or instructions.

That client computer also preferably includes a communications interface, such as a modem, a network interface (e.g., an Ethernet card), a communications port, a PCMCIA slot and card, wired or wireless systems, and the like. The communications interface allows communication through transferred signals between the client computer and external devices including networks such as the Internet and a cloud data center. Communication may be implemented using wireless or wired capability, including (by way of non-limiting example) cable, fiber optics, telephone line, cellular telephone, radio waves or other communications channels as may occur to those skilled in the art.

Such client computer establishes communication with the one more servers via, for example, the Internet, to in turn establish communication with one or more cloud data centers that implement system 200. A cloud data center may include one or more networks that are managed through a cloud management system. Each such network includes resource servers that permit access to a collection of computing resources and components of system 200, which computing resources and components can be invoked to instantiate a virtual computer, process, or other resource for a limited or defined duration. For example, one group of resource servers can host and serve an operating system or components thereof to deliver and instantiate a virtual computer. Another group of resource servers can accept requests to host computing cycles or processor time, to supply a defined level of processing power for a virtual computer. Another group of resource servers can host and serve applications to load on an instantiation of a virtual computer, such as an email client, a browser application, a messaging application, or other applications or software.

The cloud management system may comprise a dedicated or centralized server and/or other software, hardware, and network tools to communicate with one or more networks, such as the Internet or other public or private network, and their associated sets of resource servers. The cloud management system may be configured to query and identify the computing resources and components managed by the set of resource servers needed and available for use in the cloud data center. More particularly, the cloud management system may be configured to identify the hardware resources and components such as type and amount of processing power, type and amount of memory, type and amount of storage, type and amount of network bandwidth and the like, of the set of resource servers needed and available for use in the cloud data center. The cloud management system can also be configured to identify the software resources and components, such as type of operating system, application programs, etc., of the set of resource servers needed and available for use in the cloud data center.

A computer-readable medium may be provided to provide software to the cloud computing environment. Computer products store software on any computer useable medium, known now or in the future. By way of non-limiting example, such computer usable mediums may include primary storage devices (e.g., any type of random access memory), secondary storage devices (e.g., hard drives, floppy disks, CD ROMS, ZIP disks, tapes, magnetic storage devices, optical storage devices, MEMS, nanotech storage devices, etc.), and communication mediums (e.g., wired and wireless communications networks, local area networks, wide area networks, intranets, etc.). Those skilled in the art will recognize that the embodiments described herein may be implemented using software, hardware, firmware, or combinations thereof. The cloud computing environment described above is provided only for purposes of illustration.

What is claimed is:

1. A method comprising:
applying each of a set of data poisoning techniques to a target machine-learning model associated with a target computing system;
measuring, for each of the set of data poisoning techniques applied to the target machine-learning model, a corresponding performance of the target machine-learning model;
computing a set of feature values for the target machine-learning model based on the measured performance of the target machine-learning model for the set of data poisoning techniques applied to the target machine-learning model;
identifying a model structure for the target machine-learning model by comparing the set of feature values computed for the target machine-learning model to a stored plurality of model poisoning fingerprints, each fingerprint corresponding to previously generated features describing a performance of a corresponding machine-learning model structure of a plurality of machine-learning models structures after applying a set of data poisoning techniques to a machine-learning model of the corresponding machine-learning model structure; and
transmitting an indication of a match to a fingerprint in response in response to identifying the model structure.

2. The method of claim 1, further comprising generating the plurality of model poisoning fingerprints by:
applying the set of data poisoning techniques to a plurality of machine-learning models, wherein the plurality of machine-learning models comprise at least one machine-learning model of each of the plurality of machine-learning model structures; and
measuring a performance of each of the plurality of machine-learning models to generate the model poisoning fingerprints for the plurality of machine-learning model structures.

3. The method of claim 1, wherein each of the model poisoning fingerprints comprises a feature vector comprising feature values for a plurality of features describing a performance of the corresponding machine-learning model structure.

4. The method of claim 1, wherein each of the model poisoning fingerprints comprises an embedding vector describing a performance of the corresponding machine-learning model structure.

5. The method of claim 1, wherein the set of data poisoning techniques comprises at least one of:
label flipping;
backdoor attacks;
injection of outliers;
gradient poisoning;
trojan attacks;
incremental insertion points;
gradient inversion poisoning;
centroid line poisoning;
outlier sensitivity testing;
feature perturbation testing;
distribution skew injection;
class-specific noise injection; or
gradient-free attack simulation.

6. The method of claim 1, wherein the plurality of machine-learning model structures comprise at least one of a support vector machine, a random forest classifier, a Gaussian Naïve Bayes classifier, or a neural network.

7. The method of claim 1, wherein applying each of the set of data poisoning techniques to a target computing system comprises:
predicting a decision-making structure of the target machine-learning model.

8. The method of claim 7, wherein the predicted decision-making structure comprises at least one of a binary classifier, a multi-classifier, a regression model, or a time series.

9. The method of claim 1, wherein computing a set of feature values for the target machine-learning model comprises:
computing a precision or a recall of the target machine-learning model.

10. The method of claim 1, wherein identifying the model structure for the target machine-learning model comprises:
applying a k-nearest-neighbors process to the computed set of feature values and the stored plurality of model poisoning fingerprints.

11. A non-transitory computer-readable medium storing instructions that, when executed by a computer system, cause the computer system to perform operations comprising:
applying each of a set of data poisoning techniques to a target machine-learning model associated with a target computing system;
measuring, for each of the set of data poisoning techniques applied to the target machine-learning model, a corresponding performance of the target machine-learning model;
computing a set of feature values for the target machine-learning model based on the measured performance of the target machine-learning model for the set of data poisoning techniques applied to the target machine-learning model;
identifying a model structure for the target machine-learning model by comparing the set of feature values computed for the target machine-learning model to a stored plurality of model poisoning fingerprints, each fingerprint corresponding to previously generated features describing a performance of a corresponding machine-learning model structure of a plurality of machine-learning models structures after applying a set of data poisoning techniques to a machine-learning model of the corresponding machine-learning model structure; and
transmitting an indication of a match to a fingerprint in response in response to identifying the model structure.

12. The computer-readable medium of claim 11, the operations further comprising generating the plurality of model poisoning fingerprints by:
applying the set of data poisoning techniques to a plurality of machine-learning models, wherein the plurality of machine-learning models comprise at least one machine-learning model of each of the plurality of machine-learning model structures; and
measuring a performance of each of the plurality of machine-learning models to generate the model poisoning fingerprints for the plurality of machine-learning model structures.

13. The computer-readable medium of claim 11, wherein each of the model poisoning fingerprints comprises a feature vector comprising feature values for a plurality of features describing a performance of the corresponding machine-learning model structure.

14. The computer-readable medium of claim 11, wherein each of the model poisoning fingerprints comprises an embedding vector describing a performance of the corresponding machine-learning model structure.

15. The computer-readable medium of claim 11, wherein the set of data poisoning techniques comprises at least one of:
label flipping;
backdoor attacks;
injection of outliers;
gradient poisoning;
trojan attacks;
incremental insertion points;
gradient inversion poisoning;
centroid line poisoning;
outlier sensitivity testing;
feature perturbation testing;
distribution skew injection;
class-specific noise injection; or
gradient-free attack simulation.

16. The computer-readable medium of claim 11, wherein the plurality of machine-learning model structures comprise at least one of a support vector machine, a random forest classifier, a Gaussian Naïve Bayes classifier, or a neural network.

17. The computer-readable medium of claim 11, wherein applying each of the set of data poisoning techniques to a target computing system comprises:
predicting a decision-making structure of the target machine-learning model.

18. The computer-readable medium of claim 17, wherein the predicted decision-making structure comprises at least one of a binary classifier, a multi-classifier, a regression model, or a time series.

19. The computer-readable medium of claim 11, wherein computing a set of feature values for the target machine-learning model comprises:
computing a precision or a recall of the target machine-learning model.

20. The computer-readable medium of claim 11, wherein identifying the model structure for the target machine-learning model comprises:
applying a k-nearest-neighbors process to the computed set of feature values and the stored plurality of model poisoning fingerprints.
